(19) United States
(12) Patent Application Publication
(10) Pub. No.: US 2022/0372817 A1
(43) Pub. Date: Nov. 24, 2022

(54) BENDABLE SEALING PROFILE

(71) Applicant: dormakaba Deutschland GmbH, Ennepetal (DE)

(72) Inventors: Andreas FINKE, Ennepetal (DE); Carla GOCKEL, Ennepetal (DE)

(21) Appl. No.: 17/742,725

(22) Filed: May 12, 2022

(30) Foreign Application Priority Data
May 20, 2021 (EP) 21175078.1

(51) Int. Cl. E06B 7/23; E06B 7/18

(52) U.S. Cl. CPC E06B 7/2314; E06B 7/18

(57) ABSTRACT

A bendable sealing profile for arrangement on a door system, in particular on a frame element and/or on a leaf element, has, in the cross-section, a first profile part, a second profile part and a joint, by which the profile parts are connected so as to be movable in relation to one another. The sealing profile has a latching device, by which the profile parts can be latched to one another when the profile parts are transferred from an intermediate position, in particular from an angled arrangement in relation to one another, to a mounting position, in particular to a straight arrangement in relation to one another.

### CROSS-REFERENCE TO RELATED APPLICATIONS

This application claims priority to European Patent Application No. EP21175078.1, filed on May 20, 2021, the contents of which are hereby incorporated by reference in their entirety.

### TECHNICAL FIELD

The disclosure relates to a bendable sealing profile for arrangement on a door system, in particular on a frame element and/or on a leaf element, wherein the sealing profile has, in the cross-section, a first profile part, a second profile part and a joint, by means of which the profile parts are connected so as to be movable in relation to one another.

The sealing profile in the context of the disclosure does not have to primarily fulfill a sealing task and can, but does not have to, be formed as a central seal for attachment on the frame of a sliding door leaf and the sealing profile can form a seal or it forms another stop profile for attachment on a door system, in particular on a leaf element. The sealing profile should thereby in particular primarily, but not necessarily, serve to be attached on a main closing edge or on a secondary closing edge of a sliding leaf element.

### BACKGROUND

KR 200355664 Y1 discloses a bendable sealing profile for arrangement on a leaf element of a sliding leaf, wherein the sealing profile has, in the cross-section, a first profile part, a second profile part and a joint, by means of which the profile parts are connected so as to be movable in relation to one another.

The joint is designed as a film joint and the bendable sealing profile is fastened to the bracket element by way of pressing and engaging into the corresponding profile sections of said bracket element, wherein central screw connections are necessary to fixedly screw the sealing profile in the region of the joint to the leaf element. If the profile sections are located at an angle to one another, the sealing profile, in the cross-section, forms the shape of a roof edge, wherein the free ends of the profile parts have a shorter distance to one another and if the sealing profile is pressed flat such that the profile parts are transferred to a straight arrangement in relation to one another, the free ends of the profile parts can thus engage into the profile sections. Consequently, a form closure of the sealing profile can take place when arranged on the leaf element, without the sealing profile having to be introduced, for example from one side, into the frame profile of the leaf element. As a result, a notably simplified mounting and dismounting of the sealing profile is provided by the bendable design.

However, disadvantageously, a screw connection of the sealing profile in the region of the roughly centrally running joint is required since the sealing profile otherwise becomes loose again from the arrangement on the leaf element and from the engagement of the profile sections of the leaf element.

### SUMMARY

The disclosure is primarily to further improve a bendable sealing profile which enables a simplified mounting and which manages in particular without using screws, nails or other fastening means in order to securely arrange the sealing profile on the leaf element.

This is achieved proceeding from a sealing profile according to claim 1 in connection with the characterizing features. Advantageous further developments of the disclosure are indicated in the dependent claims.

The disclosure includes the technical teaching that the sealing profile has a latching device, by means of which the profile parts can be latched to one another, when the profile parts are transferred from an intermediate position, in particular from an angled arrangement in relation to one another, to a mounting position, in particular to a straight arrangement in relation to one another.

The disclosure provides a latching device which has at least one of the profile parts. When the profile parts are transferred to a straight arrangement in relation to one another, i.e. in particular are arranged on the leaf element, the latching device is designed such that it can latch or be manually latched in this straight arrangement.

Alternatively, the intermediate position can describe a position in which the profile parts are arranged straight in relation to one another, wherein the mounting position can describe a position in which the profile parts are arranged angled in relation to one another.

Alternatively, the intermediate position can describe a position in which the profile parts are arranged angled at a first angle in relation to one another, wherein the mounting position can describe a position in which the profile parts are arranged angled at a second angle in relation to one another.

The bendable sealing profile preferably has a rear side. The rear side can in particular be facing the leaf element or frame element when arranged on the leaf element or frame element. The bendable sealing profile preferably has a functional side opposite the rear side. The functional side can in particular be facing away from the leaf element or frame element when arranged on the leaf element or frame element. The latching device is thereby preferably arranged on the functional side. This leads to the advantage that the sealing profile does not have projections on the rear side in particular in the case of profile parts aligned straight in relation to one another. In this manner, the sealing profile can be attached as flat as possible to the end surface of the leaf element or of the frame element.

The latching device for example has a latching spring arranged on the first profile part and a latching groove arranged on the second profile part, wherein the latching spring latches in the latching groove when the profile parts are moved to a straight arrangement in relation to one another. Thus, the bendable sealing profile can first be placed on the end surface of the leaf element in an angled position of the profile parts and then the sealing profile is pressed against the leaf element, whereby the profile parts can be pressed into a flat, straight arrangement in relation to one another. As a result, the latching spring latches in the latching groove, wherein the position of the profile parts then achieved in relation to one another is secured by the latching device.

The latching spring is particularly advantageously formed protruding roughly perpendicularly from a base section of the first profile part and the latching spring has a latching head which forms a thickened portion on the latching spring. The extension of the latching spring beyond the base section can, deviating from a perpendicular extension, have an angle range of 55° to 90°, preferably of 65° to 90°, and particularly preferably of 75° to 90°, and in particular preferably of 85° to 90°.

The latching arm can in particular have a bore, in particular a through-bore, through which a fastening means, in particular a screw, can be guided into the first profile part in order to secure the latching arm on the first profile part. In this manner, an additional fastening of the profile parts to one another is made possible.

The latching groove can be formed on the end face of a latching arm and the latching arm is arranged on a base section of the second profile element. The latching arm thereby overlaps the joint present centrally between the profile parts and, in this respect, guides the latching groove into an opposing position to the latching spring when the profile parts are aligned straight in relation to one another. Thus, the latching spring can, for example by pressing down manually, be latched in the latching groove, wherein latching takes place over the longitudinal extension of the sealing profile, for example by hand, in sections one after another. The profile parts, the latching spring and the latching groove with the associated latching arm can be designed in one piece and of a single material. In particular, the profile parts with their base sections and the molded latching springs and latching grooves or latching arms respectively can be manufactured in an extrusion process as a continuous casting part.

On the first profile part is arranged a support strip against which the latching arm comes into contact when the profile parts are pivoted in relation to one another, resulting in a stabilization of the straight arrangement of the profile parts in relation to one another. The stabilization effect is in particular achieved when the latching spring is latched with the latching head in the latching groove and so that the latching arm rolls over the support strip.

The profile parts have, on their outer sides facing away from the joint, an engagement section which engages behind a profile section formed on the leaf element when the bendable sealing profile is arranged on the leaf element and the profile parts are transferred from the angled arrangement in relation to one another to the straight arrangement in relation to one another. This creates a form closure between the sealing profile and the leaf element since the end sections have a rear-engaging part which engages behind the profile sections of the leaf element. A further advantage is achieved when cover sections are formed on the outer sides of the profile elements which overlap the engagement section or together with the rear-engaging parts form the engagement section and if the profile elements are transferred to the straight arrangement and if the sealing profile is fastened to the leaf element, the cover elements thus cover the profile sections, which are in particular formed on the outer side of the leaf element. If the sealing profile is arranged on the leaf element, it can cover the entire end face of the leaf element and the sealing profile has, with the end face-side cover sections, a width, which corresponds to the width of the leaf element when the profile sections are transferred to the straight arrangement in relation to one another.

The joint is preferably manufactured from a material which has a greater flexibility than the material of the profile parts and/or, in this respect, forms a weaker material than the material for forming the profile parts. The flexibility can in particular be described as the reciprocal value of the rigidity.

Alternative or cumulatively, the flexibility can also be described as a counterpart of the hardness. The flexibility thereby describes in the present context an elasticity which qualifies the joint for connecting the profile parts to one another so as to be movable in relation to one another. In the case where the sealing profile is mounted on the leaf element, the joint in the mounted state of the sealing element can thus be easily pressed in such that the sealing profile is arranged on the leaf element under tension.

The flexible behavior of the material for forming the joint qualifies this material, on the one hand, for the movable connection of the two profile parts in relation to one another. If the sealing profile is attached to the leaf element, the joint can also, on the other hand, be slightly crushed with a slight excess of the profile parts in the lateral direction such that the profile parts can be arranged on the leaf element under pre-tension as a result. Therefore, the use of further mounting means may be superfluous since the sealing profile can be attached on the leaf element in a self-retaining manner.

If the latching device is latched in such that the profile parts can no longer move in relation to one another, in particular are locked, in particular rigidly in relation to one another, in their mounting position, the joint with the flexible behavior of the material of the joint causes an, in particular flat, lateral tension. As a result, the sealing profile can also rest on the leaf element in a self-retaining manner. Furthermore, the sealing profile can be secured by the latching device in this mounting position, in particular in a flat, i.e. with straight profile parts in relation to one another in the arrangement in particular. In particular, due to the flexible behavior of the joint, a play and therefore a rattling of the sealing profile on the leaf element can be pressed out to a certain extent.

The profile parts can be manufactured in particular in one piece together with the joint by means of a multi-component extrusion process. However, in the context of the disclosure, it is also conceivable to materially-connect the profile parts to the joint either with an extrusion process or it is provided that the joint is adhered, vulcanized or bonded to the profile parts.

The profile parts can be manufactured particularly advantageously from an impact-resistant hard PVC and/or the joint can be manufactured from a soft PVC. PVC plastics are thereby known for particularly high impact resistance, wherein it is possible using a correspond additive to manufacture the PVC plastic to be soft such that the flexibility required to form the joint is brought about in the material.

In order to achieve the desired properties of the joint, in particular in order to achieve a sufficient flexibility in the transverse direction of the sealing profile between the two profile parts, the joint can, transverse to its longitudinal extension of the sealing profile, have a width of 2 mm to 4 mm, preferably a width of 3 mm.

Furthermore, it is advantageous when the joint has, in the cross-section, a notch in order to generate a hinge point adjoining the notch in which the profile parts are movable in relation to one another. The notch is preferably provided on the side of the joint in its cross-section which is located on the inside when the two profile parts are bent in relation to one another such that an accumulation in the material is minimized by the notch and a joint point is defined in the joint by means of the notch about which the two profile parts are movable in relation to one another.

Further advantageously, on the functional side of the at least one profile part is formed a stop molding, which has a greater flexibility than the material of the profile parts, wherein the stop molding can be manufactured in particular of the same material as the material of the joint, preferably including a soft PVC. It is in particular provided that the profile parts are formed of one or even different materials. In particular that the profile parts are formed of an impact-resistant hard PVC. In particular that the joint is formed of a soft PVC.

According to one possible embodiment, the stop molding has an arc-shaped cross-section which forms an internal space with the base section of the profile part. The stop molding for example forms a stop for an opposing sealing profile or another profile of a door system, in particular of a frame, which together with the leaf element and the front side for receiving the sealing profile form respective closing edges. If the leaf element is transferred for example to a closed arrangement inside the door system, the stop molding can come to rest on a counter-stop.

The bendable sealing profile with the profile parts is in particular further formed such that the latching device forms a first super-elevation on the first profile part and a second super-elevation forms a super-elevation profile on the further, in particular second profile part. The stop molding can thereby be formed between the super-elevation by the latching device and the super-elevation profile.

Furthermore, it can be considered being in accordance with the disclosure:

A method for manufacturing a seal between two leaf elements or between a leaf element and a frame element, wherein a previously described bendable sealing profile is arranged in each case such that the sealing profiles, preferably with their respective previously described functional sides, can be moved into contact, in particular are in contact. The sealing profiles each preferably have at least one, in particular previously described, stop molding, wherein a closed chamber can be formed in a space between the respective stop moldings. The chamber can thereby form a thermal barrier, in particular between internal space and external space of the leaf element and/or of the frame element. Therefore, the energy efficiency between internal space and external space can be improved.

### BRIEF DESCRIPTION OF THE DRAWINGS

Further measures that improve the disclosure will be outlined in greater detail together with the description of a preferred exemplary embodiment of the disclosure on the basis of the figures, in which is shown:

FIG. 1 a view of a bendable sealing profile in an arrangement separated from a leaf element,

FIG. 2 the bendable sealing profile according to FIG. 1 in an arrangement on the leaf element,

FIG. 3 a perspective view of the bendable sealing profile,

FIG. 4 a view of two opposing leaf elements, on each of which bendable sealing profiles are arranged which are moved into contact with another in a sealing manner,

FIG. 5 a view of a modified exemplary embodiment of two sealing profiles with support shells moved towards one another, against which the latching arm of an opposing sealing profile can move into contact, and

FIG. 6 a view of a modified exemplary embodiment of two sealing profiles with elastic lip moved towards one another, against which the latching arm of an opposing sealing profile can move into contact.

### DETAILED DESCRIPTION OF THE DRAWINGS

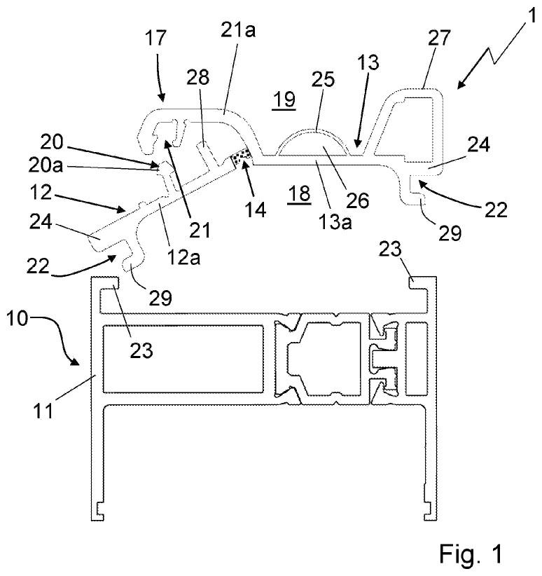

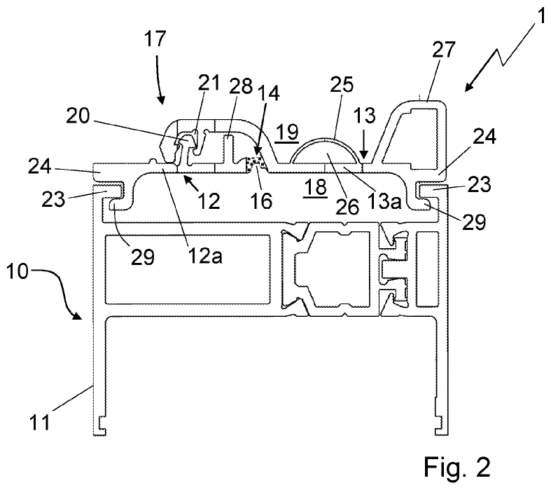

FIGS. 1 and 2 show a bendable sealing profile 1 for arrangement on a leaf element 11 of a door system 10, wherein the latter is shown in a simplified manner only by a closing edge profile of a leaf element 11. FIG. 1 shows a bendable sealing profile 1 before arrangement on the leaf element 11 and FIG. 2 shows the bendable sealing profile 1 after being arranged on the leaf element 11.

The bendable sealing profile 1 has a first profile element 12 and a second profile element 13 as essential components and the two profile elements 12 and 13 are connected to one another by means of a joint 14. The sealing profile 1 is represented just like the leaf element 11 only in the cross-section and the sealing profile 1 extends along a longitudinal extension which is perpendicular to the image plane.

Before the sealing profile 1 is arranged on the leaf element 11, the profile parts 12 and 13 have an arrangement inclined, bent to a certain extent, in relation to one another or they are moved into this arrangement in relation to one another and they are connected to the joint 14 towards the respectively other side. The profile parts 12 and 13 have base sections 12a and 13a, which, when the cross-section of the sealing profile 1 is viewed in the bent arrangement before mounting on the leaf element 11, form an angle in relation to one another, see FIG. 1 and after arrangement, the base sections 12a and 13a extend in a common plane, see FIG. 2.

The material of the joint 14 is formed to be weaker than the material of the profile parts 12 and 13 and, according to the exemplary embodiment shown, the profile parts 12 and 13 have an impact-resistant hard PVC, while the joint 14 has a soft PVC. The joint 14 can be configured in connection with the profile parts 12 and 13 such that the straight extension of the base sections 12a, 13a shown in FIG. 2 is present without force action on the sealing profile 1 and only to mount the sealing profile 1 on the leaf element 11 can it be bent according to FIG. 1 so as the joint 14 elastically deforms. If the sealing profile 1 is arranged on the leaf element 11, the base sections 12a, 13a again extend due to the inherent elasticity of the joint 14 in a common plane and therefore parallel to the end face of the leaf element 11.

Rear-engaging parts 29 are formed on the outer edges of the profile parts 12 and 13 and together with cover sections 24 form engagement sections 22. If the sealing profile 1 is arranged on the leaf element 11, profile sections 23 formed on the leaf element 11 can thus engage into the engagement sections 22 such that the sealing profile 1 is ultimately arranged in a form-fitting manner on the leaf element 11 when the base sections 12a, 13a extend in a common plane and therefore run parallel to the end face of the leaf element 11. The cover sections 24 of the profile parts 12 and 13 thereby form outwardly terminating edges which laterally cover the profile sections 23 of the leaf element 11. If the sealing profile 1 is arranged on the leaf element 11, it thus covers the entire end face of the leaf element 11.

On the base section 12a of the first profile part 12 is molded a latching spring 20 which has a thickened latching head 20a. On the base section 13a of the second profile part 13 is formed a latching groove 21 on the end face of a latching arm 21a and the latching arm 21a serves to move the latching groove 21 so as to overlap with the latching spring 20 and latch them together when the base sections 12a, 13a extend straight in relation to one another. If the sealing profile 1 is arranged on the leaf element 11, the latching spring 20 can be latched in the latching groove 21 such that the arranged position of the sealing element 1 on the leaf element 11 is therefore secured. In order that the sealing profile 1 cannot loosen unintentionally when the latching spring 2 is arranged latched in the latching groove 21, a support strip 28 is arranged under the latching arm 21a such that it is not possible to remove the sealing profile 1 from the leaf element without loosening the latching connection between the latching spring 20 and the latching groove 21.

A notch 16 in the joint 14 is described in FIG. 2 which serves to generate a hinge point adjoining the notch 16 in which the profile parts 12, 13 are movable in relation to one another. The notch 16 is preferably provided on the side of the joint 14 in its cross-section which is located on the inside when the two profile parts 12, 13 are bent in relation to one another such that an accumulation in the material is minimized by the notch 16 and a joint point is defined in the joint 14 by means of the notch 16 about which the two profile parts 12, 13 are movable in relation to one another.

The latching device 17 formed with the latching spring 20 and the latching groove 21 forms a first super-elevation over the base section 12a of the first profile part 12, wherein a further super-elevation profile 27 is provided on the second profile part 13. Between the latching device 17 and the super-elevation profile 27 is located a stop molding 25, which, according to this exemplary embodiment, is configured in an arc-shape and is similarly designed from a weaker material, in particular from the same weaker material as the joint 14. An internal space 26 is formed under the arc-shaped stop molding 25 such that the stop molding 25 can also easily deflect, in particular when the leaf element 11 is closed and the sealing profile 1 enters into contact against an opposing counter closing edge.

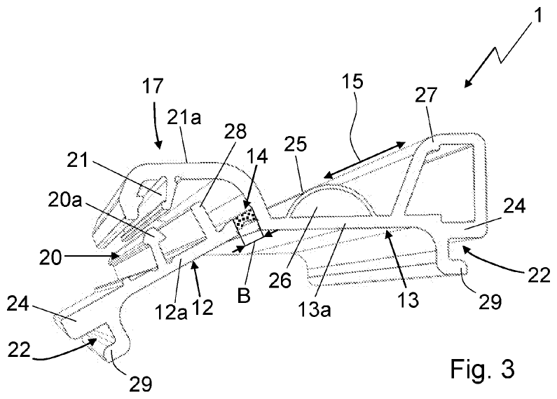

FIG. 3 shows a perspective view of the sealing profile 1 with the first profile part 12 and the second profile part 13. The profile parts 12 and 13 are shown with their essential component as base sections 12a and 13a, on which the latching spring 20 and the latching arm 21a with the latching groove 21 are located. Above the base section 13a of the second profile part 13 is shown the stop molding 25 under which the internal space 26 is formed. Furthermore, on the base section 13a is molded the super-elevation profile 27 which merges on the outer side into the cover section 24. Under the cover sections 24 of the profile parts 12 and 13 are shown the engagement sections 22 which terminate on the underside with the rear-engaging parts 29.

Advantageously, in the space between the respective stop moldings 25 is formed a closed chamber which can serve as a thermal barrier between internal space and external space of the leaf elements and therefore improves the energy requirement.

The joint 14 connects the two profile parts 12 and 13 to one another, wherein the components of the sealing profile 1 all extend in the longitudinal extension 15 substantially with identically-shaped cross-sectional profile. The sealing profile 1 can thereby for example have a length adapted to the length of a profile element of the leaf element 11 of a door system 10 according to the FIGS. 1 and 2.

The joint 14 has a width B which is for example 2 mm to 4 mm, preferably 3 mm.

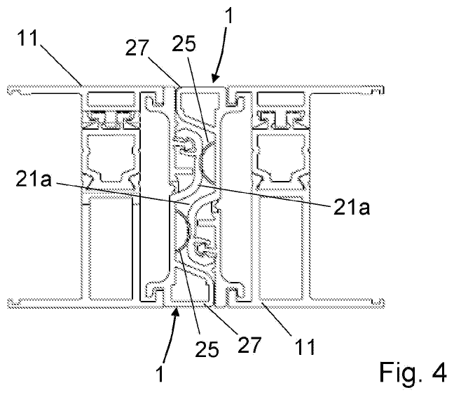

A view of two opposing leaf elements 11 is shown in FIG. 4, on each of which a bendable sealing profile 1 is arranged which are moved into contact against one another in a sealing manner. In this case, the arc-shaped, outwardly arched stop molding 25 abuts against the outer side of the latching arm 21a of the latching device 17 to achieve the sealing effect, wherein the stop molding 25 has a greater flexibility due to the weaker material and can deflect until the super-elevation profile 27 of each of the sealing profiles 1 abuts on the opposing base section 12a and 13a or on their cover sections 24 as end face-side extensions of the profile parts 12, 13.

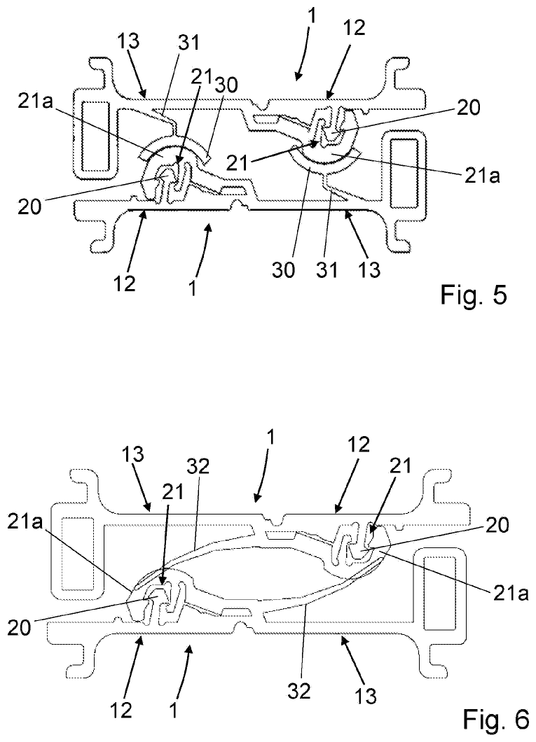

FIG. 5 shows a view of a modified exemplary embodiment of two sealing profiles 1 moved towards one another, which are provided with support shells 30 formed such that the latching arms 21a of the respectively opposing sealing profile 1 can enter into contact against the support shells 30. In this way, a different kind of stop molding is created. To generate flexibility via elastic webs 31, the support shells 30 are arranged on the respectively second profile parts 13 which can alternatively also be arranged on the first profile parts 12. The rear sides of the latching arms 21a are shaped such that they fit roughly precisely into the support shells 30. If the sealing profiles 1 reach one another as shown, the support shells 30 thus support, with slight elastic resilience of the webs 31, the latching of the latching springs 20 into the latching grooves 21. Advantageously, in the space between the respective support shells 30 is formed a closed chamber which can serve as a thermal barrier between internal space and external space of the leaf elements and therefore improves the energy requirement.

FIG. 6 shows a further modified exemplary embodiment of two sealing profiles 1 moved towards one another, which are provided with elastic lips 32 and are in turn formed such that the elastic lips 32 of the respectively opposing sealing profile 1 can enter into contact against the rear sides of the latching arms 21a. In this way, a further kind of stop molding is created. The elastic lips 32 are formed flexibly and attached, in particular molded in one piece, on the second profile parts 13. The elastic lips 32 can alternatively also be arranged on the first profile parts 12. If the sealing profiles 1 reach one another as shown, the elastic lips 32 thus support, with slight elastic resilience, the latching of the latching springs 20 into the latching grooves 21. Advantageously, in the space between the respective lips 32 is formed a closed chamber which can serve as a thermal barrier between internal space and external space of the leaf elements and therefore improves the energy requirement.

The design of the disclosure is not restricted to the preferred exemplary embodiment indicated above. In fact, a number of variants is conceivable which make use of the represented solution even in the case of fundamentally different designs. All features and/or advantages emerging from the claims, the description or the drawings, including constructive details or spatial arrangements, may be essential to the disclosure even in the most varied combinations.

1. A bendable sealing profile for arrangement on a door system, wherein the sealing profile comprises, in the cross-section, a first profile part, a second profile part, and a joint, by which the profile parts are connected so as to be movable in relation to one another,
wherein
the sealing profile has a latching device, by which the profile parts are configured to be latched to one another when the profile parts are transferred from an intermediate position, to a mounting position.

2. The bendable sealing profile according to claim 1,
wherein
the bendable sealing profile has a rear side, which faces a leaf element when arranged on the leaf element, and in that the bendable sealing profile has an opposing functional side, which faces away from the leaf element when arranged on the leaf element, wherein the latching device is arranged on the functional side or on the rear side.

3. The bendable sealing profile according to claim 1,
wherein
the latching device has a latching spring arranged on the first profile part and a latching groove arranged on the second profile part, wherein the latching spring is configured to be latched in the latching groove when the profile parts are moved to the mounting position.

4. The bendable sealing profile according to claim 1,
wherein
the latching spring protrudes from a base section of the first profile part substantially perpendicularly, and has a latching head
and/or in that the latching groove is formed on an end face of a latching arm which is arranged on a base section of the second profile part and the joint is formed overlapping.

5. The bendable sealing profile according to claim 1,
wherein
on the first profile part is arranged a support strip against which the latching arm enters into contact when the profile parts are pivoted in relation to one another, resulting in a stabilization of a straight arrangement of the profile parts in relation to one another.

6. The bendable sealing profile according to claim 1,
wherein
the first profile parts on their outer sides facing away from the joint each have an engagement section for engaging behind a profile section formed on a leaf element when the bendable sealing profile is arranged on the leaf element and the profile parts are transferred from the intermediate position to the mounting position.

7. The bendable sealing profile according to claim 6,
wherein
the outer sides have a cover section covering the engagement section, which covers the profile section formed on the leaf element towards the functional side of the sealing profile when the bendable sealing profile is arranged on the leaf element and the profile parts are transferred from the intermediate position to the mounting position.

8. The bendable sealing profile according to claim 1,
wherein
the profile parts and the joint are manufactured together by a multi-component extrusion process.

9. The bendable sealing profile according to claim 1,
wherein
the joint is formed from a material, which has a greater flexibility than the material of the profile parts and/or in that the profile parts have an impact-resistant hard PVC and/or in that the joint has a soft PVC.

10. The bendable sealing profile according to claim 1,
wherein
the joint is materially-connected laterally adjoining the profile parts by the extrusion process and/or in that the joint is adhered, vulcanized, or bonded to the profile parts.

11. The bendable sealing profile according to claim 1,
wherein
the joint has a notch in the cross-section in order to generate, in the material of the joint, a hinge point adjoining the notch in which the profile parts are movable in relation to one another.

12. The bendable sealing profile according to claim 1,
wherein
the joint has a width of 2 mm to 4 mm running transversely to a longitudinal extension of the sealing profile.

13. The bendable sealing profile according to claim 1,
wherein
on the functional side of at least one of the profile parts is formed a stop molding which has a greater flexibility than the material of the profile parts and/or in that the stop molding is formed from a material identical to the joint.

14. The bendable sealing profile according to claim 13,
wherein
the stop molding is formed such that the stop molding corresponds to the shape of the latching arm, such that the stop molding is formed at least partially in a shell shape.

15. The bendable sealing profile according to claim 1,
wherein
the latching device forms a super-elevation on the first profile part and in that a super-elevation profile is formed on the second profile part and/or wherein the stop molding is formed between the super-elevation and the super-elevation profile.
